(19) United States
(12) Patent Application Publication
(10) Pub. No.: US 2006/0246777 A1
(43) Pub. Date: Nov. 2, 2006

(54) RF microwave connector for telecommunication

(75) Inventor: Shun-Ping Wang, Hsin-Tien City (TW)

Correspondence Address: BRUCE H. TROXELL, SUITE 1404, 5205 LEESBURG PIKE, FALLS CHURCH, VA, 22041, US

(73) Assignee: Insert Enterprise Co., Ltd.

(21) Appl. No.: 11/115,108

(22) Filed: Apr. 27, 2005

(51) Int. Cl. H01R 9/05

(52) U.S. Cl. 439/582

(57) ABSTRACT

A RF microwave connector for telecommunication comprises a receptacle; a metal housing of the receptacle is combined with an insulator; a male terminal is combined with the hollow portion of the insulator; the male terminal has a main body, a raised portion is extended from one end of the main body for inserting a female terminal; an arc-shaped clamping section is disposed at another end of the main body, two edges of the clamping section are symmetrically arched so as to allow the edges of the clamping section to be bended oppositely smoothly to clamp inner wires of a coaxial cable stably when that the clamping section is combined with the inner wires is processed.

### BACKGROUND OF THE INVENTION

1. Field of the Invention

The present invention relates to an electric connector, and more particularly to a receptacle of a RF microwave connector for telecommunication.

2. Description of Related Art

Please refer to FIG. 1. A tin soldered micro-mini-connector available in the market comprises a receptacle 10 and plug 20. The bottom 10 of the receptacle 10 is soldered onto a circuit board of a notebook computer, personal digital assistant (PDA) or cellular phone. And, the plug 20 can be inserted in the receptacle 10 and another end thereof is connected to an antenna of a device such as a cellular phone through a signal line so as to make contact with signals. The receptacle 10 has a metal housing 11 and the lower end thereof is connected to an insulator 12. The insulator 12 is extended in the housing 11 and the central part thereof is formed with a raised portion 121. A male terminal 13 is combined in the raised portion 121. A sheet-typed lower end 131 of the male terminal 13 is extended out of the insulator 12 and the housing 11. The plug 20 has a metal cover 21. The housing 21 is combined with an insulator 22. A hollow portion 221 of the insulator 22 is combined with a female terminal 23. The female 23 is constituted by two opposite contact sheets 231 separated a small distance. When the plug 20 is inserted in the receptacle 10, engage the two contact sheets 231 of the female terminal 23 of the plug 20 at the two sides of the female terminal 13 of the receptacle 10 to allow two signal terminals to be communicated; the cover 21 is covered outside of the housing 11 to allow two ground terminals to be communicated.

The receptacle mentioned above is a structure welded to a circuit board; it is objected to the limitation that it must be fixed on the circuit in practical application, a set of connectors with a same length of wire are not allowed to use in variety of circuit boards with different specifications or circuit arrangements.

Please refer to FIG. 2. If a wire 241 of a plug 24 is not long enough to allow it to be connected to a receptacle, an adaptor 14 with male terminals at the both ends thereof is used to connect with another plug 25 to allow a plug at another end of a wire 251 connected to the plug 25 to be then connected to the receptacle.

Please refer to FIGS. 3A, 3B, 3C, 3D and 3E. Adaptors 14, 15, 16, 17 and 18 with male terminals respectively at the both ends of each thereof have a variety of application types.

The receptacle 10 combined on a circuit board shown in FIG. 1 also can be changed to the forms such as receptacles 31, 32, 33 and 34 shown in FIGS. 4A, 4B, 4C and 4D; male terminals 311, 321, 331 and 341 thereof are formed a line respectively with wires 312, 322, 332 and 342 and partition plates 313, 323, 333 and 343 are respectively disposed at the peripheries thereof. Holes are respectively disposed in the partition plate 313, 323 and 333 for allowing the plates to be fixed on the housing plates of other machines by screwing screws through them. A plug 24 can be combined with the receptacle 33 from one side of the partition plate 333, as FIG. 5 shows. Threads are disposed at the flank side of the partition plate 343 for allowing a nut 314 to fix the plate 342 on the housing plate of another machine.

Please refer to FIGS. 6, 7A and 7B. Taiwan patent No. 250,406 and Japan Patent No. 3,103,794 granted to the applicant of the present patent disclose a RF microwave connector for telecommunication; a receptacle 40 of the first embodiment thereof comprises a metal housing 41, a insulator 42 combined with the housing 41 and a male terminal 43 combined with the insulator 42. The housing 41 is combined on the periphery of the insulator 42 and combined with a wire 44, as FIG. 7 shows. The wire 44 combined with the receptacle 44 and the wire 241 combined with the plug 24 can also be a same wire to allow the both ends of the wire 44 respectively have the plug 24 and the receptacle 40 so that it can be used as a general extended line of the plug 24 and the receptacle 40.

Please refer to FIGS. 8 and 9. A receptacle 50 of the second embodiment of the patent mentioned above comprises a metal housing 51, an insulator 52 combined with the housing 51 and a male terminal 53 combined with the insulator 52. The metal housing 51 is combined with the periphery of the insulator 53 and combined with the periphery of a wire 54, as FIG. 8 shows. The receptacle 54 can be engaged with a plug 24. One end of the metal housing 51 is connected to a material tape 511 so as to benefit the automation production and assembly of a production line, as FIG. 9 shows.

The manufacturing way welding the coaxial cable and the female terminal manually mentioned above cannot be replaced with an automatic machine manufacturing way; it is labor and time wasting.

Please refer to FIGS. 10A to 10C. Two opposite contact plates 61 are disposed at one end of another kind of known coaxial microwave connector 60 and a clamping section 62 is disposed at another end thereof. Two contact plates 61 are used to clamp a male terminal of a receptacle. The bottom of the clamping section 62 is formed as an arc-shaped and a bendable edge 621 is extended upward from one side of the bottom thereof. Inner wires 631 of a coaxial cable 63 are wrapped in between the bottom of the clamping section 62 and the bended bendable edge 621, as FIG. 10B shows.

Although an automatic machine can replace manual labor in the manufacturing way clamping the inner wires 631 of the coaxial cable 63 tightly by bending the bendable edge 621 of the clamping section 62 mentioned above is rather labor and time saving, the bendable edge 621 is very long and a more sophisticated and expensive bending facility is needed to bend the bendable edge 621 into a half circle type smoothly to contact closely with another edge of the arc bottom. If the bended radian of the bendable edge 621 is not smooth so that it cannot contact closely with another edge of the arc bottom of the clamping section 62, this will influence the function clamping the inner wires 431 closely and further influence the transmission quality of the connector and produce a bad product. The structure without welding is a structure used to combine the female terminal with the coaxial cable and not to combine male terminal and the coaxial cable.

### SUMMARY OF THE INVENTION

For improving the combination structure of a male terminal of a receptacle of a coaxial microwave connector and inner wires of a coaxial cable, allowing the manufacturing more convenient and cheap and enabling the ratio of bad product rate to be lowered down, the present invention is proposed.

The main object of the present invention is to provide a RF microwave connector for telecommunication, enabling a manufacturing combination between a male terminal of a receptacle and inner wires of a coaxial cable to be easier.

Another object of the present invention is to provide a RF microwave connector for telecommunication, enabling a male terminal of a receptacle to be combined with inner wires of a coaxial cable tightly and not to loose so as to enhance the good product rate.

Still another object of the present invention is to provide a RF microwave connector for telecommunication, even if using simpler and cheaper machine, a male terminal of a receptacle and inner wires of a coaxial cable can be combined tightly.

### BRIEF DESCRIPTION OF THE DRAWINGS

The present invention can be more fully understood by reference to the following description and accompanying drawings, in which:

FIG. 1 is a cross sectional view, showing a conventional receptacle and plug;

FIG. 2 is a prospective view, showing a conventional receptacle, plug and adaptor.

FIGS. 3A to 3E are prospective views, showing a variety of different types of adaptors;

FIG. 4A to 4D are prospective views, showing a variety of conventional receptacles;

FIG. 5 is a prospective view, showing another kind of conventional plug and receptacle;

FIG. 6 is an explosive view, showing components of a conventional receptacle;

FIGS. 7A and 7B are prospective and cross sectional views, showing a conventional plug and a receptacle shown in FIG. 6;

FIG. 8 is a prospective view, showing another kind of receptacle and plug;

FIG. 9 is an explosive view, showing components of a receptacle shown in FIG. 8;

FIGS. 10A to 10C are explosive, combined and cross sectional views, showing a female terminal combined with a cable;

FIGS. 11A to 11C are explosive, combined and cross sectional views, showing a male terminal combined with a cable according to a first preferred embodiment of the present invention;

FIGS. 12A to 12C are explosive, combined and cross sectional views, showing a male terminal combined with a cable according to a second preferred embodiment of the present invention;

FIGS. 13A to 13C are explosive, combined and cross sectional views, showing a male terminal combined with a cable according to a third preferred embodiment of the present invention;

FIGS. 14A and 14B are prospective and cross sectional views, respectively showing a male terminal and receptacle of a fourth preferred embodiment according to the present invention;

FIGS. 15A and 15B are prospective and cross sectional views, respectively showing a male terminal and receptacle of a fifth preferred embodiment according to the present invention; and

FIGS. 16A and 16B are prospective and cross sectional views, respectively showing a male terminal and receptacle of a sixth preferred embodiment according to the present invention.

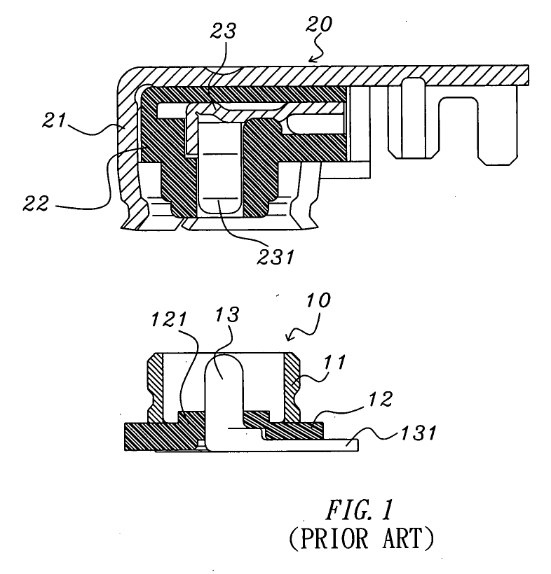

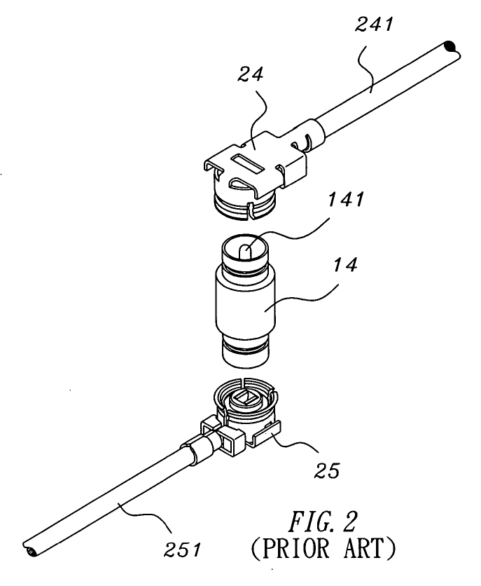

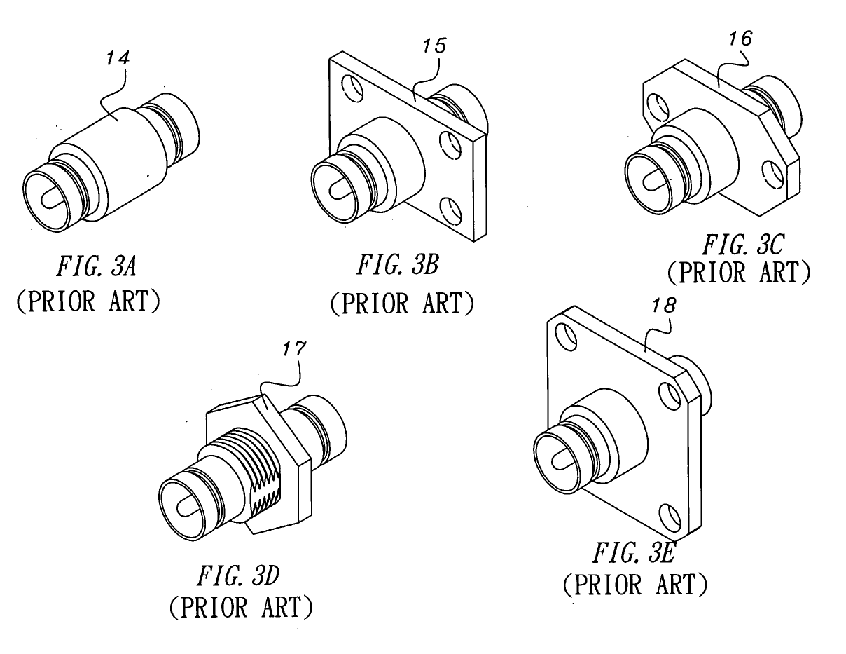

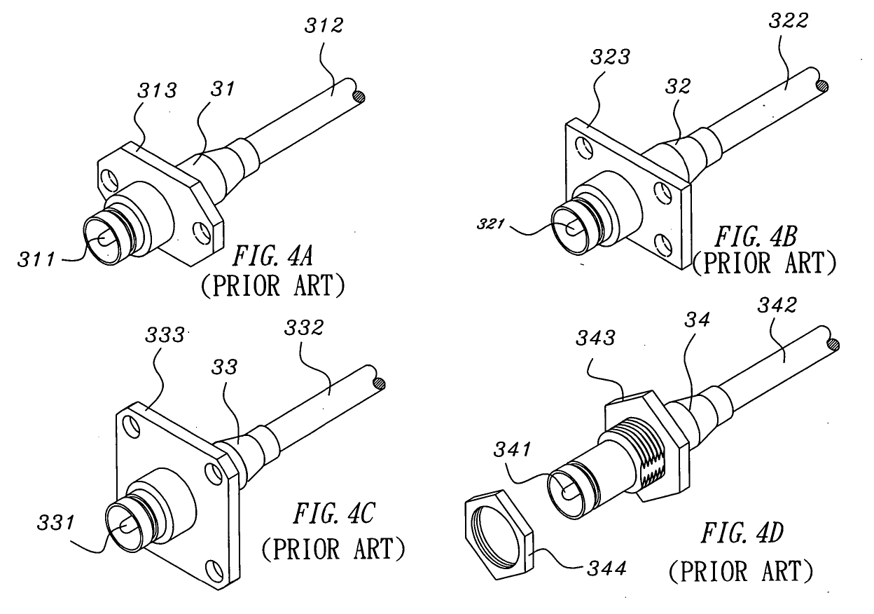

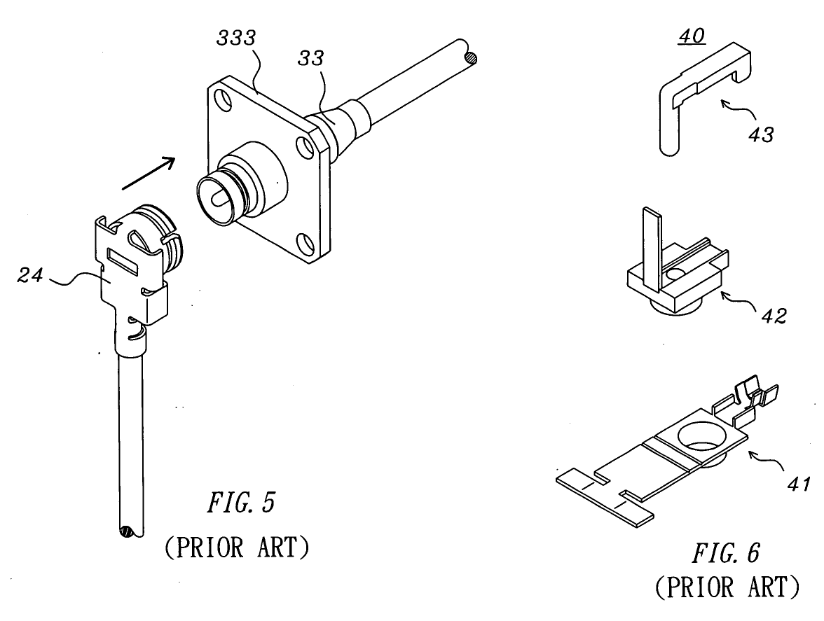

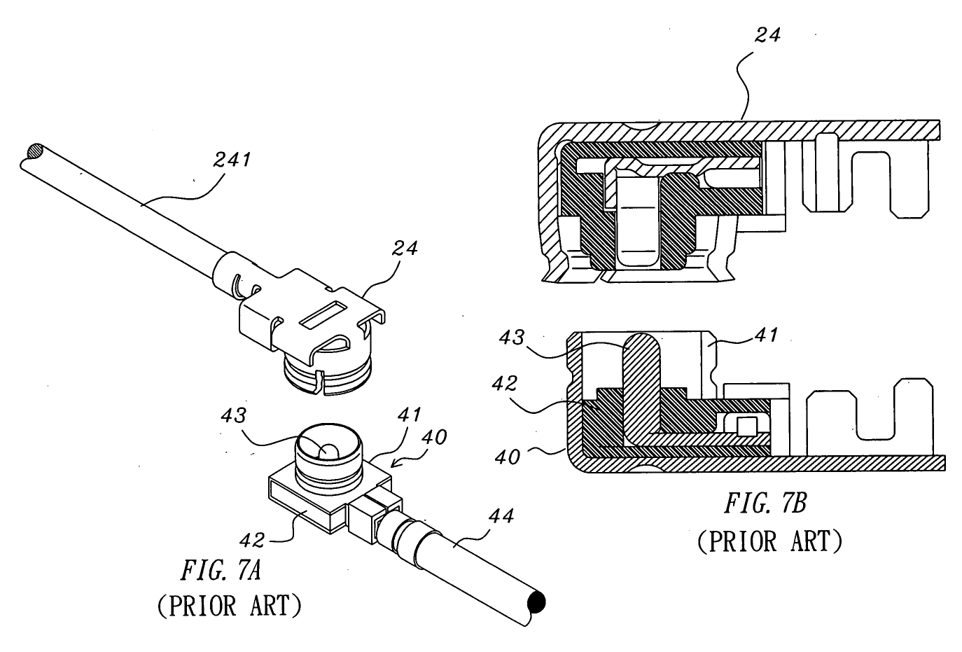

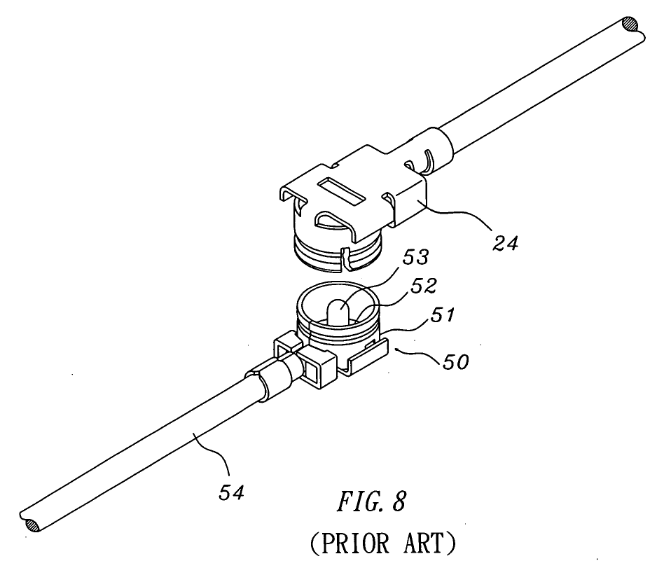

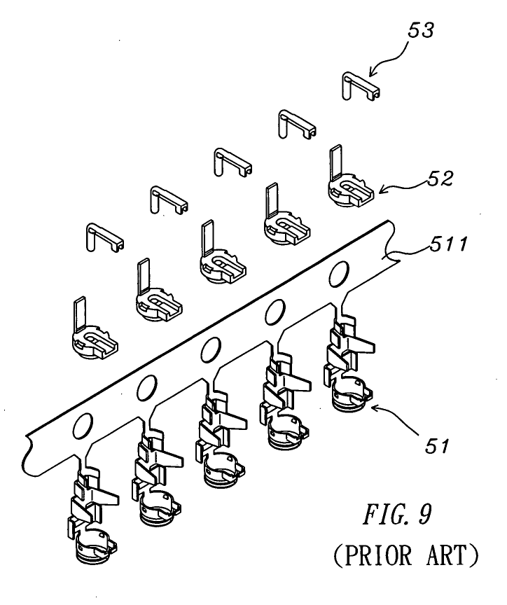

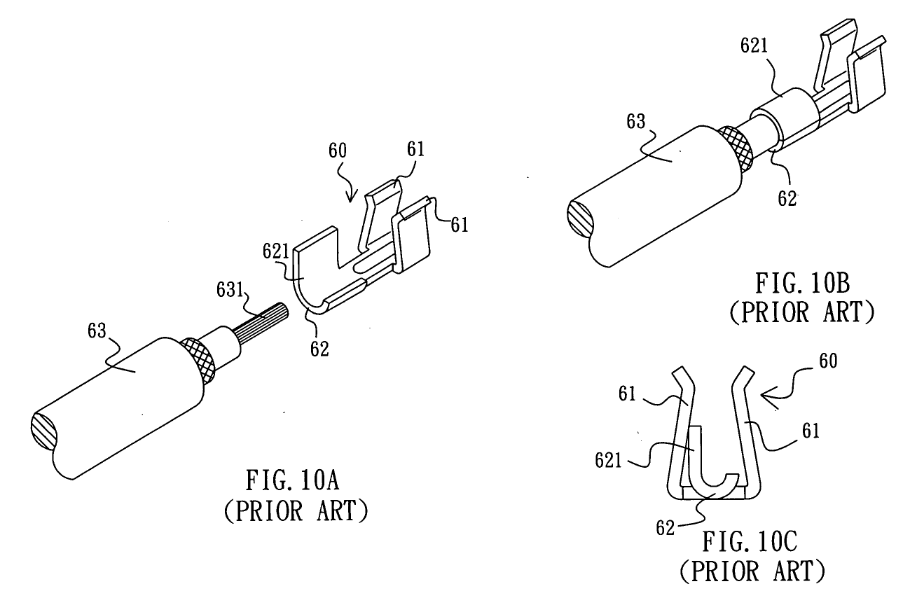

### DETAILED DESCRIPTION OF THE PREFERRED EMBODIMENTS

Please refer to FIG. 11A to 11C. A male terminal 71 of a first preferred embodiment according to the present invention has a main body 711. A raised portion 712 is extended from one end of the main body 711 used for combining with a female terminal. An arc-shaped clamping section 713 is disposed at another end of the main body 711 and a groove hole 714 is disposed in the arc face of the clamping section 713. Two edges 715 and 716 of the clamping section 713 are symmetrically arched.

The design that the two edges 715 and 716 of the clamping section 713 of the male terminal 71 are symmetrically arched in the preferred embodiment is suitable for using only a simpler and cheaper manufacturing machine, the edges 715 and 716 can be bended face to face smoothly to clamp inner wires 811 of a coaxial cable 81 stably. A part of the inner wires 811 corresponding to the groove hole 714 will be deformed by a force and sunk into the groove hole 714 during the inner wires 811 is clamped by the clamping section 713. The inner wires 811 are rather not allowed to separate from the clamping section 713 when the coaxial cable 81 is objected to a pull force causing it to be separated from the clamping section 713 because there is a resisting force caused from the deformation part of the inner wire 811 sunk in the groove hole 714.

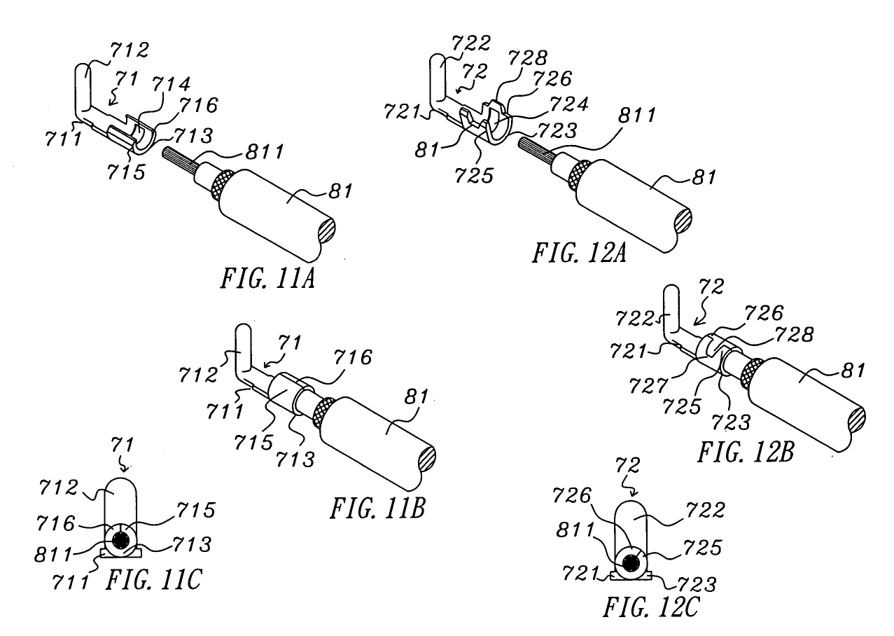

Please refer to FIGS. 12A to 12C. A male terminal 72 of a second preferred embodiment according to the present invention whose shape is approximately same as the one of the male terminal 71 of a first preferred embodiment mentioned above also has a main body 721, raised portion 722, clamping section 723 and groove hole 724; the difference between them is in that a corresponding notch 727 and tenon 728 are respectively disposed at the end parts of two edges 725 and 726 of the clamping section 63. When the edges 725 and 726 are bended, the tenon 728 is caused to buckle into the notch 727, this helps allowing the edges 725 and 726 to be bended symmetrically accurately and the contact ends to be stayed closely so that the crooked contact does rather not happen. Therefore, the largest clamping force is exerted on the inner wires 811 of the coaxial cable 81 to allow to be combined with the clamping section 723 more stably.

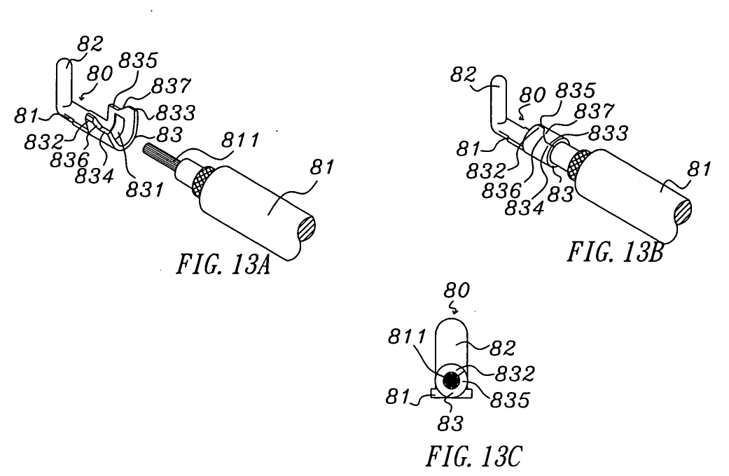

Please refer to FIGS. 13A to 13C. A male terminal 80 of a third preferred embodiment according to the present invention whose shape is approximately same as the one of the female terminal 71 of a first preferred embodiment mentioned above also has a main body 81, raised portion 82, clamping section 83 and groove hole 831; the difference between them is in that corresponding raised sections 832, 833, recessed sections 834, 835 and inclined sections 836, 837 are respectively disposed at the end parts of two edges of the clamping section 83. when the two edges are bended, the raised section 832, the inclined section 836 and the recessed section 834 of one edge are caused to contact respectively with the recessed section 835, the inclined section 837 and raised section 833 of another edge, this helps allowing the edges to be bended symmetrically accurately and the contact ends to be stayed closely so that the crooked contact does rather not happen. Therefore, the largest clamping force is exerted on the inner wires 811 of the coaxial cable 81 to allow to be combined with the clamping section 83 more stably.

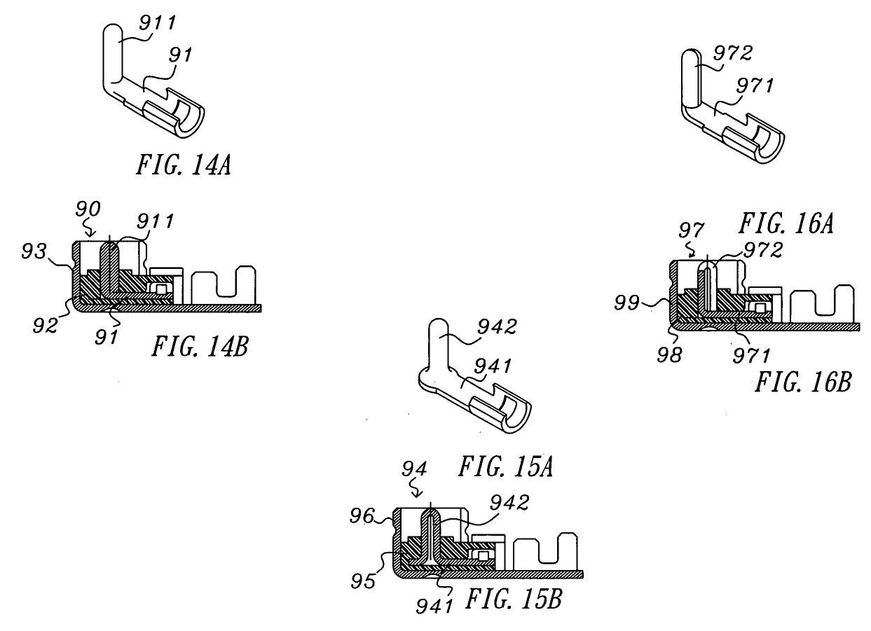

Please refer to FIGS. 14A, 15A and 16A. Raised portions 911, 942 and 972 of male terminals 91, 941 and 971 can respectively be a stamped full raised portion 911, drawn hollow raised portion 942 and covered hollow raised portion 972. receptacles 90, 94 and 97 respectively with male terminals 91, 941 and 971 can be respectively constituted by combining the hollow portions of insulators 92, 85 and 98 respectively with the male terminals 91, 941 and 971 and metal housings 93, 96 and 99 respectively the insulators 92, 95 and 98.

The present invention can allow a male terminal of a receptacle and inner wires of a coaxial cable can be easily manufactured to combine, combined closely and not to be loosen and rather simple in use, and a cheaper machine can allow the male terminal of the receptacle and the inner wires of the coaxial cable can be combined closely.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1-7. (canceled)

8. A radio frequency (RF) microwave connector for telecommunication using a coaxial cable comprising:
a) a receptacle having a metal housing;
b) an insulator located in the metal housing and having a hollow portion; and
c) a male terminal extending through the hollow portion of the insulator and having:
i) a main body;
ii) a raised portion located at a first end of the main body; and
iii) a clamping section located at a second end of the main body and having a groove hole and an arch shaped surface having a first edge having a shape corresponding to a shape of a second edge, the first edge engaging the second edge and fixing an inner wire of the coaxial cable in the clamping section, a portion of the inner wire is located in the groove hole,
wherein the first edge has a notch and the second edge has a tenon inserted into the notch located on an exterior of the inner wire opposite the groove hole,
wherein the raised portion of the male terminal is selected from a group of comprising a stamped full raised portion, and a covered hollow raised portion,
wherein each of the notch and the tenon are symmetrical.

9. (canceled)

10. The RF microwave connector according to claim 8, further comprising a plug inserted into the receptacle and having:
a) a metal plug housing;
b) a plug insulator located in the metal plug housing and having a hollow portion; and
c) a female terminal extending through the hollow portion of the insulator and having two contact sheets spaced apart, the raised portion of the male terminal is inserted between the two contact sheets.

11. A RF radio frequency (RF) microwave connector for telecommunication using a coaxial cable comprising:
a) a receptacle having a metal housing;
b) an insulator located in the metal housing and having a hollow portion; and
c) a male terminal extending through the hollow portion of the insulator and having:
i) a main body;
ii) a raised portion located at a first end of the main body; and
iii) a clamping section located at a second end of the main body and having a groove hole and an arch shaped surface having a first edge having a shape corresponding to a shape of a second edge, the first edge engaging the second edge and fixing an inner wire of the coaxial cable in the clamping section, a portion of the inner wire is located in the groove hole,
wherein each of the first edge and the second edge has a raised section, a recessed section, and an inclined section located between the raised section and the recessed section,
wherein the raised section of the first edge engages the recessed section of the second edge, the recessed section of the first edge engages the raised section of the second edge, and the inclined section of the first edge engages the inclined section of the second edge located on an exterior of the inner wire opposite the groove hole,
wherein the raised portion of the male terminal is selected from a group of comprising a stamped full raised portion and a covered hollow raised portion,
wherein each of the raised section and the recessed section is located on an opposing edge of the clamping section.

12. (canceled)

13. The RF microwave connector according to claim 11, further comprising a plug inserted into the receptacle and having:
a) a metal plug housing;
b) a plug insulator located in the metal plug housing and having a hollow portion; and
c) a female terminal extending through the hollow portion of the insulator and having two contact sheets spaced apart, the raised portion of the male terminal is inserted between the two contact sheets.
